(19) United States
(12) Patent Application Publication
(10) Pub. No.: US 2008/0224953 A1
(43) Pub. Date: Sep. 18, 2008

(54) PLASMA DISPLAY PANEL

(76) Inventors: Sangmin Hong, Gumi-City (KR); Kieon Eom, Gumi-City (KR); Beesu Kwon, Gumi-City (KR)

Correspondence Address: KED & ASSOCIATES, LLP, P.O. Box 221200, Chantilly, VA, 20153-1200, US

(21) Appl. No.: 12/048,051

(22) Filed: Mar. 13, 2008

(30) Foreign Application Priority Data
Mar. 13, 2007 (KR) 10-2007-0024638

(51) Int. Cl. G09G 3/28; H01J 17/49

(52) U.S. Cl. 345/60; 313/584; 315/169.4

(57) ABSTRACT

A plasma display panel is disclosed. The plasma display panel includes a front substrate including a scan electrode and a sustain electrode each having a single-layered structure, a rear substrate including an address electrode, and a barrier rib. The scan and sustain electrodes each include at least one line portion intersecting the address electrode, at least one projecting portion that projects from the at least one line portion toward the center of the discharge cell, and a connection portion that connects the at least two line portions to each other. A ratio of a shortest interval between the scan and sustain electrodes to a height of the barrier rib lies substantially in a range between 0.35 and 1.1.

This application claims the benefit of Korean Patent Application No. 10-2007-0024638 fled on Mar. 13, 2007 which is hereby incorporated by reference.

### BACKGROUND

1. Field

An exemplary embodiment relates to a plasma display panel.

2. Description of the Related Art

A plasma display panel includes a phosphor layer inside discharge cells partitioned by barrier ribs and a plurality of electrodes.

When driving signals are applied to the electrodes of the plasma display panel, a discharge occurs inside the discharge cells. In other words, when the plasma display panel is discharged by applying the driving signals to the discharge cells, a discharge gas filled in the discharge cells generates vacuum ultraviolet rays, which thereby cause phosphors positioned between the barrier ribs to emit light, thus producing visible light. An image is displayed on the screen of the plasma display panel due to the visible light.

### SUMMARY OF THE DISCLOSURE

In one aspect, a plasma display panel comprises a front substrate on which a scan electrode and a sustain electrode are positioned parallel to each other, the scan electrode and the sustain electrode each having a single-layered structure, a rear substrate on which an address electrode is positioned to intersect the scan electrode and the sustain electrode, and a barrier rib that is positioned between the front substrate and the rear substrate to partition a discharge cell, wherein the scan electrode and the sustain electrode each include at least one line portion intersecting the address electrode, at least one projecting portion that projects from the at least one line portion toward the center of the discharge cell, and a connection portion that connects the at least two line portions to each other, wherein a ratio of a shortest interval between the scan electrode and the sustain electrode to a height of the barrier rib lies substantially in a range between 0.35 and 1.1.

In another aspect, a plasma display panel comprises a front substrate on which a scan electrode and a sustain electrode are positioned parallel to each other, the scan electrode and the sustain electrode each having a single-layered structure, a rear substrate on which an address electrode is positioned to intersect the scan electrode and the sustain electrode, and a barrier rib that is positioned between the front substrate and the rear substrate to partition a discharge cell, wherein the scan electrode and the sustain electrode each include at least one line portion intersecting the address electrode, at least one projecting portion that projects from the at least one line portion toward the center of the discharge cell, the projecting portion including a first portion and a second portion between the first portion and the line portion, a width of the first portion being larger than a width of the second portion, and a connection portion that connects the at least two line portions to each other, wherein a ratio of a shortest interval between the scan electrode and the sustain electrode to a height of the barrier rib lies substantially in a range between 0.35 and 1.1.

In still another aspect, a plasma display panel comprises a front substrate on which a scan electrode and a sustain electrode are positioned parallel to each other, the scan electrode and the sustain electrode each hating a single-layered structure, a rear substrate on which an address electrode is positioned to intersect the scan electrode and the sustain electrode, and a barrier rib that is positioned between the front substrate and the rear substrate to partition a discharge cell, wherein the scan electrode and the sustain electrode each include at least one line portion intersecting the address electrode, at least one projecting portion that projects from the at least one line portion toward the center of the discharge cell, and a connection portion that connects the at least two line portions to each other, wherein a ratio of a shortest interval between the scan electrode and the sustain electrode to a height of the barrier rib lies substantially in a range between 0.35 and 1.1, wherein at least one of an interval between the two projecting portions of the scan electrode and an interval between the two projecting portions of the sustain electrode is larger than a width of the address electrode.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 shows a structure of a plasma display panel according to an exemplary embodiment;

FIG. 2 is a diagram for explaining in detail a scan electrode and a sustain electrode;

FIG. 3 is a diagram for explaining a scan electrode and a sustain electrode each having a multi-layered structure;

FIG. 4 is a diagram for explaining an example of a structure of a scan electrode and a sustain electrode;

FIGS. 5 and 6 are diagrams for explaining a relationship between a height of a barrier rib and a discharge;

FIGS. 7 to 9 are diagrams for explaining a relationship between a height of a barrier rib and a shortest distance between scan and sustain electrodes;

FIG. 10 is a diagram for explaining a shortest distance between scan and sustain electrodes;

FIG. 11 is a diagram for explaining an example of another form of a connection portion;

FIG. 12 is a diagram for explaining an example of the case where scan and sustain electrodes each include a tail portion;

FIGS. 13 and 14 are diagrams for explaining an example of another form of a projecting portion;

FIG. 15 is a diagram for explaining an example of a projecting portion with the curvature;

FIG. 16 shows a frame for achieving a gray scale of an image in the plasma display apparatus; and

FIG. 17 is a diagram for explaining an example of an operation of the plasma display panel.

### DETAILED DESCRIPTION OF EMBODIMENTS

Reference will now be made in detail embodiments of the invention examples of which are illustrated in the accompanying drawings.

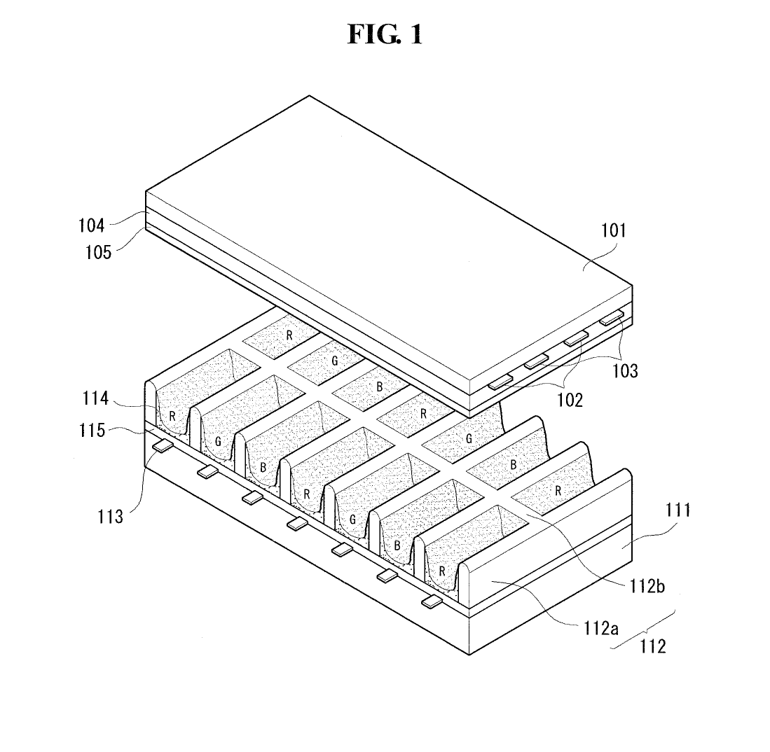

FIG. 1 shows a structure of a plasma display panel according to an exemplary embodiment.

As shown in FIG. 1, a plasma display panel according to an exemplary embodiment may include a front substrate 101, on which a scan electrode 102 and a sustain electrode 103 each having a single-layered structure are positioned parallel to each other, and a rear substrate 111 on which an address electrode 113 is positioned to intersect the scan electrode 102 and the sustain electrode 103.

An upper dielectric layer 104 may be positioned on the scan electrode 102 and the sustain electrode 103 to limit a discharge current of the scan electrode 102 and the sustain electrode 103 and to provide electrical insulation between the scan electrode 102 and the sustain electrode 103.

A protective layer 105 may be positioned on the upper dielectric layer 104 to facilitate discharge conditions. The protective layer 105 may include a material having a high secondary electron emission coefficient, for example, magnesium oxide (MgO).

A lower dielectric layer 115 may be positioned on the address electrode 113 to provide electrical insulation of the address electrodes 113.

Barrier ribs 112 of a stripe type, a well type, a delta type, a honeycomb type, and the like, may be positioned on the lower dielectric layer 115 to partition discharge spaces (i.e., discharge cells). Hence, a red discharge cell emitting red (R) light, a blue discharge cell emitting blue (B) light, and a green discharge cell emitting green (G) light, and the like, may be positioned between the front substrate 101 and the rear substrate 111. In addition to the red, green, and blue discharge cells, a white (W) or yellow (Y) discharge cell may be further positioned.

Widths of the red, green, and blue discharge cells may be substantially equal to one another. Further, a width of at least one of the red, green, and blue discharge cells may be different from widths of the other discharge cells. For instance, a width of the red discharge cell may be the smallest, and widths of the green and blue discharge cells may be larger than the width of the red discharge cell. The width of the green discharge cell may be substantially equal to or different from the width of the blue discharge cell.

Further, a width of a phosphor layer, which will be described later, may be changed in relation to the width of the discharge cell. For instance, a width of a green phosphor layer inside the green discharge cell and a width of a blue phosphor layer inside the blue discharge cell are larger than a width of a red phosphor layer inside the red discharge cell. Hence, a color temperature of an image displayed on the plasma display panel 100 can be improved.

The barrier rib 112 may include a first banner rib 112b and a second barrier rib 112a. A height of the first barrier rib 112b may be different from a height of the second barrier rib 112a. For instance, a height of the first barrier rib 112b may be smaller than a height of the second barrier rib 112a.

Each of the discharge cells partitioned by the barrier ribs 112 is filled with a predetermined discharge gas.

A phosphor layer 114 may be positioned inside the discharge cells to emit visible light for an image display during an address discharge. For instance, red, green, and blue phosphor layers may be positioned inside the discharge cells. In addition to the red, green, and blue phosphor layers, white or yellow phosphor layer may be further positioned.

A thickness of at least one of the red, green, and blue phosphor layers may be different from thicknesses of the other phosphor layers. For instance, a thickness of the green phosphor layer or the blue phosphor layer may be larger than a thickness of the red phosphor layer. The thickness of the green phosphor layer may be substantially equal or different from the thickness of the blue phosphor layer.

While the upper dielectric layer 104 and the lower dielectric layer 115 each have a single-layered structure in FIG. 1, at least one of the upper dielectric layer 104 or the lower dielectric layer 115 may have a multi-layered structure.

A black matrix (not shown) capable of absorbing external light may be further positioned on the barrier rib 112 to prevent the external light from being reflected by the barrier rib 112. Further, the black matrix may be positioned at a predetermined location of the front substrate 101 corresponding to the barrier rib 112.

While the address electrode 113 may have a substantially constant width or thickness, a width or thickness of the address electrode 113 inside the discharge cell may be different from a width or thickness of the address electrode 113 outside the discharge cell. For instance, a width or thickness of the address electrode 113 inside the discharge cell may be larger than a width or thickness of the address electrode 113 outside the discharge cell.

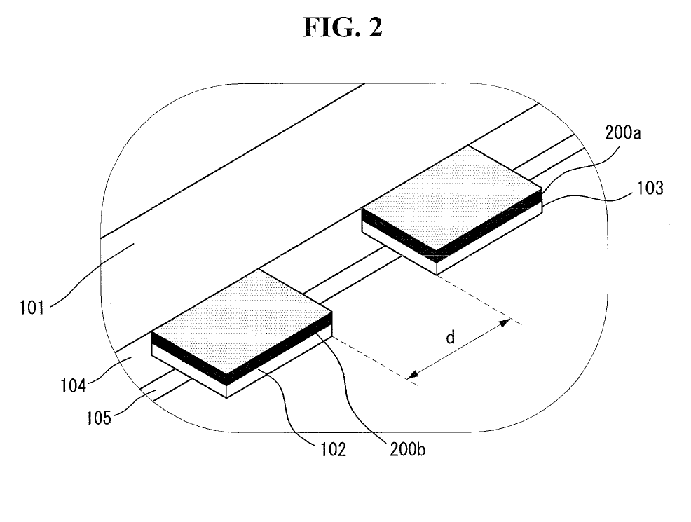

FIG. 2 is a diagram for explaining in detail a scan electrode and a sustain electrode.

As shown in FIG. 2, the scan electrode 102 and the sustain electrode 103 each have a single-layered structure, and may be spaced apart from each other at an Interval d therebetween.

The scan electrode 102 and the sustain electrode 103 may include an opaque metal material with electrical conductivity. Examples of the opaque metal material with electrical conductivity include silver (Ag), gold (Au), copper (Cu), and aluminum (Al) that are cheaper than ITO. The scan and sustain electrodes 102 and 103 having the above-described single-layered structure may be called an ITO-less electrode in which a transparent electrode is omitted.

Black layers 200a and 200b may be positioned between the front substrate 101 and the scan electrode 102 and the sustain electrode 103, thereby preventing discoloration of the front substrate 101. Colors of the black layers 200a and 200b is darker than colors of the scan electrode 102 and the sustain electrode 103.

For instance, in case that the front substrate 101 directly contacts the scan electrode 102 or the sustain electrode 103, a predetermined contact area of the front substrate 101 may change into a yellow-based color. The change of color is called a migration phenomenon. The black layers 200a and 200b can prevent the migration phenomenon by preventing the front substrate 101 from directly contacting the scan electrode 102 or the sustain electrode 103.

The black layers 200a and 200b may include a black material of a dark color, for example, ruthenium (Ru).

Since the black layers 200a and 200b are positioned between the front substrate 101 and the sustain electrode 103 and between the front substrate 101 and the scan electrode 102, respectively, the generation of reflection light can be prevented even if the scan and sustain electrodes 102 and 103 are formed of a material with a high reflectance.

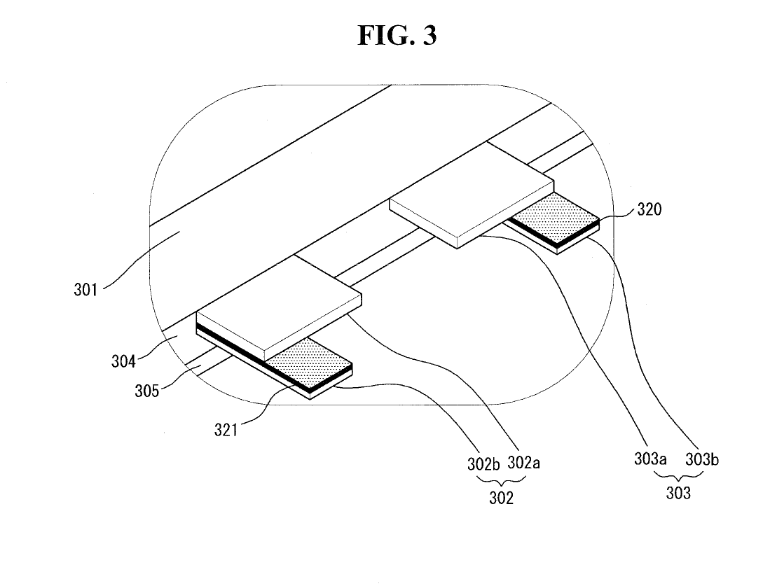

FIG. 3 is a diagram for explaining a scan electrode and a sustain electrode each having a multi-layered structure.

As shown in FIG. 3, each of a scan electrode 302 and a sustain electrode 303 may have a multi-layered structure. For instance, each of the scan electrode 302 and the sustain electrode 303 may include a double-layered structure including transparent electrodes 302a and 303a and bus electrodes 302b and 303b.

The bus electrodes 302b and 303b may include a substantially opaque material, for instance, silver (Ag), gold (Au), and aluminum (Al). The transparent electrodes 302a and 303a may include a substantially transparent material, for instance, indium-tin-oxide (ITO).

Black layers 320 and 330 may be formed between the transparent electrodes 302a and 303a and the bus electrodes 302b and 303b so as to prevent the reflection of external light caused by the bus electrodes 302b and 303b.

As above, in case that the scan electrode 302 and the sustain electrode 303 have the multi-layered structure, after the transparent electrodes 302a and 303a are formed on a front substrate 301, the bus electrodes 302b and 303b have to be formed on the transparent electrodes 302a and 303a.

On the other hand, as shown in FIG. 2, in case that the scan electrode 102 and the sustain electrode 103 have the single-layered structure, the scan electrode 102 and the sustain electrode 103 can be formed on the front substrate 101 though one process. In other words, a manufacturing process of the scan and sustain electrodes having the single-layered structure is simpler than a manufacturing process of the scan and sustain electrodes having the multi-layered structure, and thus the manufacturing cost can be reduced.

Further, because the transparent material such as ITO used in the transparent electrodes 302a and 303a of FIG. 3 is relatively expensive, the manufacturing cost of the scan and sustain electrodes of FIG. 2 not including transparent electrodes can be further reduced.

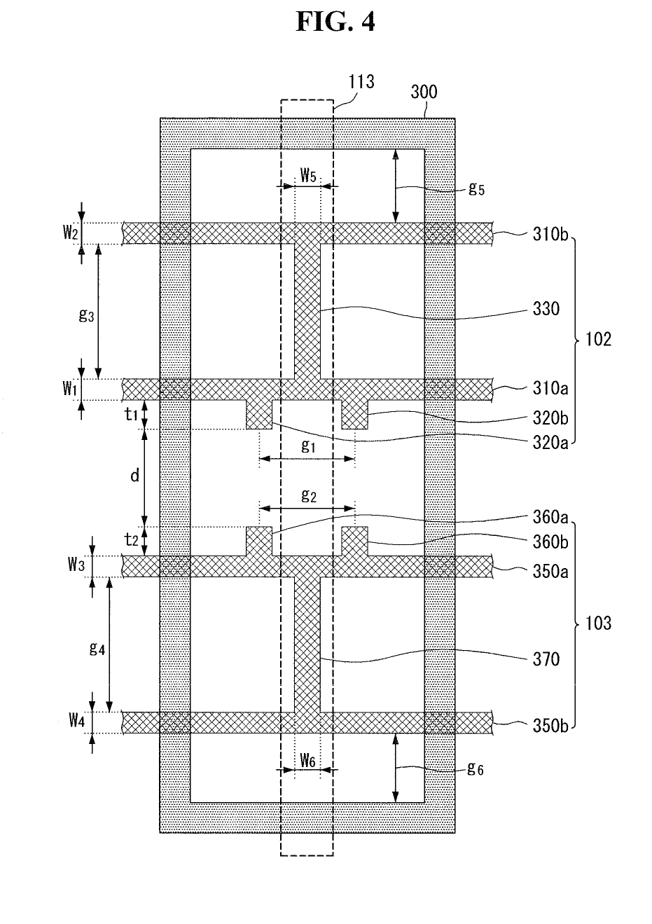

FIG. 4 is a diagram for explaining an example of a structure of a scan electrode and a sustain electrode.

As illustrated in FIG. 4, the scan electrode 102 may include a plurality of line portions 310a and 310b intersecting the address electrode 113, and a plurality of projecting portions 320a and 320b projecting from the line portions 310a and 310b. The sustain electrode 103 may include a plurality of line portions 350a and 350b intersecting the address electrode 113, and a plurality of projecting portions 360a and 360b projecting from the line portions 350a and 350b.

Although the scan electrode 102 and the sustain electrode 103 each include two projecting portions in FIG. 4, the number of projecting portions is not limited thereto. For instance, each of the scan electrode 102 and the sustain electrode 103 may include three projecting portions. The scan electrode 102 may include four projecting portions, and the sustain electrode 103 may include three projecting portions.

The line portions 310a, 310b, 350a, and 350b each have a predetermined width. For instance, the first and second line portions 310a and 310b of the scan electrode 102 have widths W1 and W2, respectively. The first and second line portions 350a and 350b of the sustain electrode 103 have widths W3 and W4, respectively. The widths W1, W2, W3 and W4 may have a substantially equal value. At least one of the widths W1, W2, W3 or W4 may have a different value. For instance, the widths W1 and W3 may be about 35 μm, and the widths W2 and W4 may be about 45 μm larger than the widths W1 and W3.

In case that an interval g3 between the first and second line portions 310a and 310b of the scan electrode 102 and an interval g4 between the first and second line portions 350a and 350b of the sustain electrode 103 are excessively large, it is difficult to diffuse a discharge generated between the scan electrode 102 and the sustain electrode 103 into the second line portion 310b of the scan electrode 102 and the second line portion 350b of the sustain electrode 103. On the other hand, in case that the intervals g3 and g4 are excessively small, it is difficult to diffuse the discharge into the rear of the discharge cell. Accordingly, the intervals g3 and g4 may lie substantially in a range between about 170 μm and about 210 μm.

To sufficiently diffuse the discharge starting to occur between the scan electrode 102 and the sustain electrode 103 into the rear of the discharge cell, a shortest interval g5 between the scan electrode 102 and a barrier rib 300 in a direction parallel to the address electrode 113 and a shortest interval g6 between the sustain electrode 103 and the barrier rib 300 in a direction parallel to the address electrode 113 may lie substantially in a range between about 120 μm and about 150 μm.

The projecting portions 320a, 320b, 360a, and 360b projects from the line portions 310a, 310b, 350a, and 350b toward the center of the discharge cell. For instance, the projecting portions 320a and 320b of the scan electrode 102 project from the first line portion 310a of the scan electrode 102 toward the center of the discharge cell, and the projecting portions 360a and 360b of the sustain electrode 103 project from the first line portion 350a of the sustain electrode 103 toward the center of the discharge cell.

In FIG. 4, an interval d between the projecting portions 320a and 320b of the scan electrode 102 and the projecting portions 360a and 360b of the sustain electrode 103 may be substantially equal to a shortest interval between the scan electrode 102 and the sustain electrode 103.

The projecting portions 320a, 320b, 360a, and 360b are spaced apart from each other at a predetermined interval. For instance, the projecting portions 320a and 320b of the scan electrode 102 are spaced apart from each other at an interval g1. The projecting portions 360a and 360b of the sustain electrode 103 are spaced apart from each other at an interval g2. The intervals g1 and g2 may be substantially equal to or different from each other.

In case that the intervals g1 and g2 are excessively small, it is difficult to widely diffuse a discharge generated between the projecting portions 320a and 320b of the scan electrode 102 and the projecting portions 360a and 360b of the sustain electrode 103 inside the discharge cell. Further, it is difficult to widely diffuse an address discharge generated between the scan electrode 103 and the address electrode 113 inside the discharge cell. Accordingly, it may be advantageous that the intervals g1 and g2 are larger than a width of the address electrode 113 so as to widely diffuse the discharge.

The intervals g1 and g2 may lie substantially in a range between about 75 μm and about 110 μm so as to sufficiently secure the discharge efficiency.

A length to of the projecting portions 320a and 320b and a length t2 of the projecting portions 360a and 360b may lie substantially in a range between about 50 μm and about 55 μm so that a discharge between the scan electrode 102 and the sustain electrode 103 starts to occur at a relatively low voltage.

Each of the scan electrode 102 and the sustain electrode 103 may include a connection portion for connecting at least two line portions. For instance, the scan electrode 102 includes a connection portion 330 for connecting the first and second line portions 310a and 310b, and the sustain electrode 103 includes a connection portion 370 for connecting the first and second line portions 350a and 350b.

A discharge may start to occur the between the projecting portions 320a and 320b projecting from the first line portion 310a of the scan electrode 102 and the projecting portions 360a and 360b projecting from the first line portion 350a of the sustain electrode 103. The discharge is diffused into the first line portion 310a of the scan electrode 102 and the first line portion 350a of the sustain electrode 103, and then is diffused into the second line portion 310b of the scan electrode 102 and the second line portion 350b of the sustain electrode 103 through the connection portions 330 and 370.

The connection portions 330 and 370 are mainly used to diffuse the generated discharge into the second line portions 310b and 350b of the scan and sustain electrodes 102 and 103. In case that widths W5 and W6 of the connection portions 330 and 370 are excessively wide, an aperture ratio may be reduced. Hence, a luminance may be reduced. Accordingly, it may be advantageous that the widths W5 and W6 may be equal to or smaller than the widths W1, W2, W3, and W4 of the line portions 310a, 310b, 350a, and 350b.

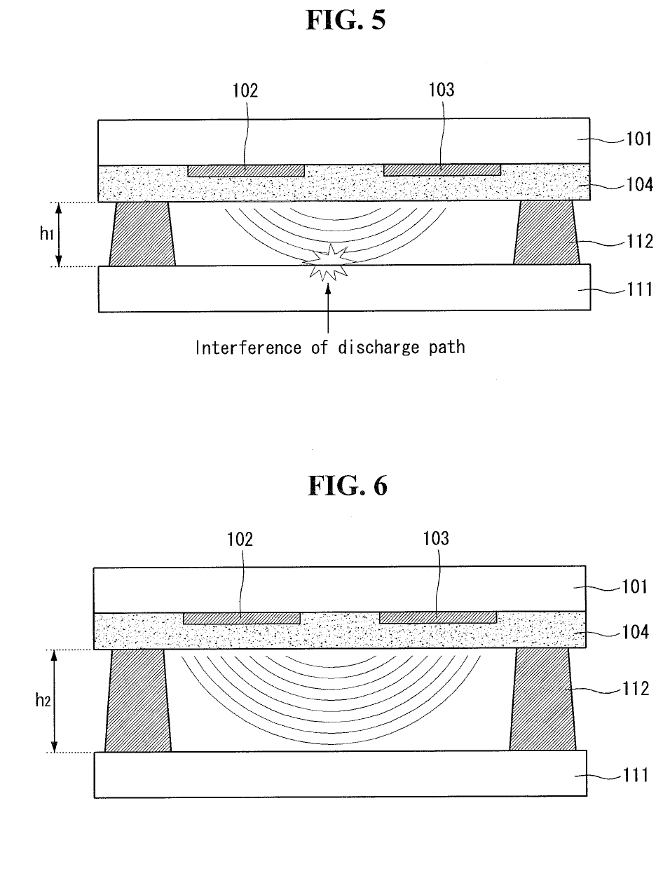

FIGS. 5 and 6 are diagrams for explaining a relationship between a height of a barrier rib and a discharge.

As shown in FIG. 5, in case that a height h1 of the barrier rib 112 is excessively low, a space for a discharge generated between the scan electrode 102 and the sustain electrode 103 may not be sufficiently secured between the front substrate 101 and the rear substrate 111. Hence, a path of the discharge staring to occur between the scan electrode 102 and the sustain electrode 103 may be interfered. As a result, it is difficult to diffuse the discharge into the rear of the discharge cell. The drive efficiency and a luminance of a displayed image may be reduced.

On the other hand, as shown in FIG. 6, in case that a height h2 of the barrier rib 112 is sufficiently high, a space for a discharge generated between the scan electrode 102 and the sustain electrode 103 can be sufficiently secured between the front substrate 101 and the rear substrate 111, and a path of the discharge can be sufficiently secured. As a result the discharge can be sufficiently diffused into the rear of the discharge cell. A reduction in the drive efficiency and the luminance can be suppressed.

If an interval between the scan electrode 102 and the sustain electrode 103 increases, a range of a path of a discharge generated between the scan electrode 102 and the sustain electrode 103 may widen and the discharge path may be close to the rear substrate 111. Therefore, the height of the barrier rib 112 may be determined in consideration of the interval between the scan electrode 102 and the sustain electrode 103.

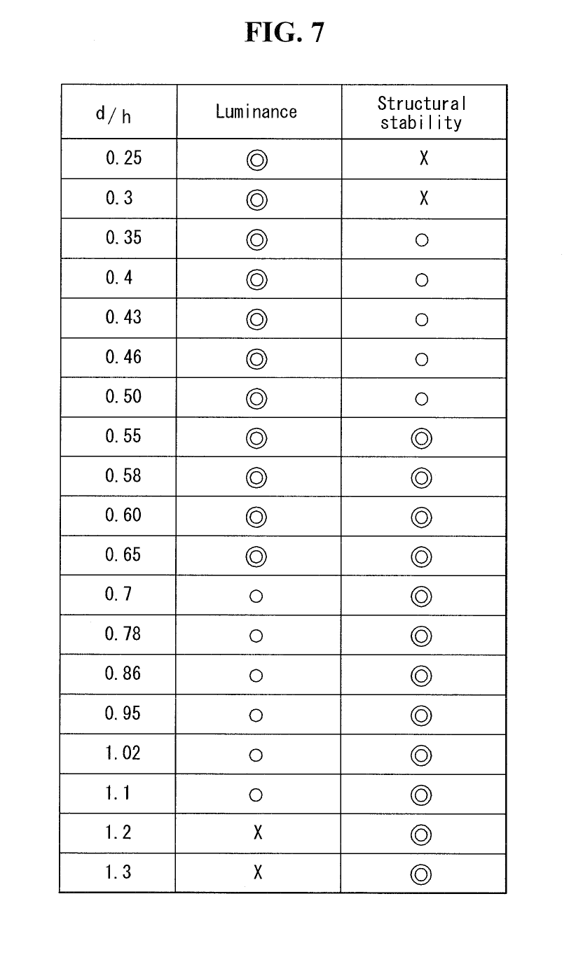

FIGS. 7 to 9 are diagrams for explaining a relationship between a height of a barrier rib and a shortest distance between scan and sustain electrodes. In FIGS. 7 to 9, as in FIG. 4, the scan electrode 102 and the sustain electrode 103 each include at least one line portion, at least one projecting portion, and a connection portion, and a shortest interval between the scan and sustain electrodes 102 and 103 is the interval d (refer to FIG. 4) between the projecting portion of the scan electrode 102 and the projecting portion of the sustain electrode 103.

FIG. 7 is a table measuring a luminance of an image and a structural stability of the barrier rib by changing a ratio d/h of a shortest interval d to a height h of the barrier rib in a state where the shortest interval d between the scan and sustain electrodes is set at 75 μm. In FIG. 7, ⊚ indicates that the luminance of the displayed image or the structural stability of the barrier rib is excellent; ◯ indicates that the luminance of the displayed image or the structural stability of the barrier rib is good; and X indicates that the luminance of the displayed image or the structural stability of the barrier rib is bad.

As shown in FIG. 7, when the ratio d/h is 0.25 to 0.65 (i.e., when the height h of the barrier rib is sufficiently larger than the shortest interval d between the scan and sustain electrodes), a discharge space can be sufficiently secured to the extent that a discharge starting to occur between the scan and sustain electrodes can be diffused into the rear of the discharge cell. Hence, the image luminance is excellent (⊚).

When the ratio d/h is 0.7 to 1.1, the image luminance is good (◯).

When the ratio d/h is equal to or more than 1.2 (i.e., when the height h of the barrier rib is excessively smaller than the shortest interval d between the scan and sustain electrodes), a path of a discharge staring to occur between the scan and sustain electrodes is interfered. Hence, the image luminance is bad (X).

When the ratio d/h is 0.25 to 0.3, a strength of the barrier rib is relatively weak because the height h of the barrier rib is excessively high. Hence, the structural stability of the barrier rib is bad (X). Further, in case that the height h of the barrier rib further increases, the barrier rib may not stand a weight of the front substrate or the rear substrate in a process for coalescing the front substrate with the rear substrate. As a result, the barrier rib may collapse. In this case, the structural stability of the barrier rib can be improved by increasing a width of the barrier rib. However, if the width of the barrier rib increases, a volume of the discharge space decreases, and thus the amount of phosphor material capable of being coated inside the discharge cell may decrease. Hence, the luminance may be reduced.

When the ratio d/h is 0.35 to 0.50, the strength of the barrier rib is proper because the height h of the barrier rib is proper. Hence, the structural stability of the barrier rib is good (◯).

When the ratio d/h is equal to or more than 0.55, the structural stability of the barrier rib is excellent (⊚).

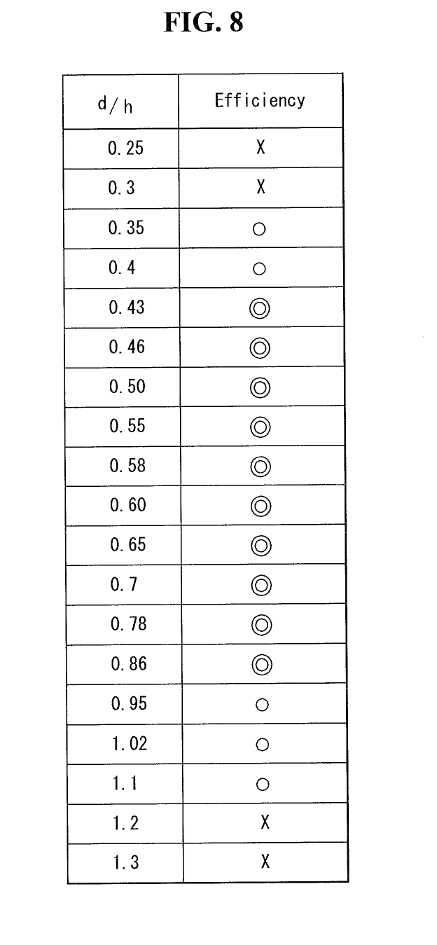

FIG. 8 is a table measuring the drive efficiency by changing the ratio d/h of the shortest interval d between the scan and sustain electrodes to the height h of the barrier rib in a state where the height h of the barrier rib is set at 125 μm. In FIG. 8, ⊚ indicates that the drive efficiency is excellent; ◯ indicates that the drive efficiency is good; and X indicates that the drive efficiency is bad.

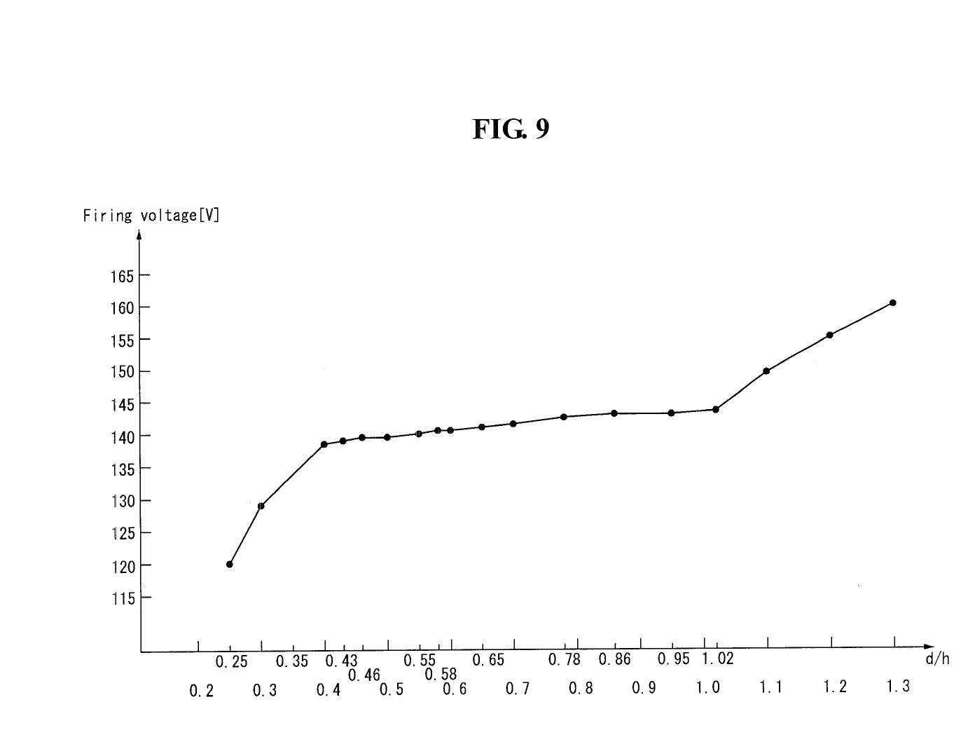

FIG. 9 is a graph measuring a firing voltage between the scan and sustain electrodes by changing the ratio d/h of the shortest interval d between the scan and sustain electrodes to the height h of the barrier rib in a state where the height h of the barrier rib is set at 125 μm.

As shown in FIGS. 8 and 9, when the ratio d/h is 0.25 to 0.3, because the shortest interval d between the scan and sustain electrodes is very short, a positive column region is not sufficiently utilized during the generation of a discharge and a negative glow region is mainly utilized. Hence, the quantity of light is small during the generation of the discharge and the drive efficiency is bad. The firing voltage between the scan and sustain electrodes has a relatively low voltage of 120V to 128V within the above range of the ratio ft. However, in this case, it is difficult to control the discharge because the shortest interval d between the scan and sustain electrodes is very short, and also a voltage margin may be bad.

When the ratio d/h is 0.35 to 0.4, the drive efficiency is good because the shortest interval d between the scan and sustain electrodes is proper. The firing voltage between the scan and sustain electrodes ranges from 135V to 137V within the above range of the ratio d/h.

When the ratio d/h is 0.43 to 0.86, because the shortest interval d between the scan and sustain electrodes is sufficiently long, a positive column region can be sufficiently utilized during the generation of a discharge. Hence, the drive efficiency is excellent. The firing voltage between the scan and sustain electrodes has a stable voltage of 138V to 146V within the above range of the ratio d/h.

When the ratio d/h is 0.95 to 1.1, the shortest interval d between the scan and sustain electrodes is sufficiently long. However, the firing voltage between the scan and sustain electrodes has a slightly high voltage of 146V to 149V. Hence, the drive efficiency is good.

When the ratio d/h is equal to or more than 1.2, the shortest interval d between the scan and sustain electrodes is sufficiently long. However, the firing voltage between the scan and sustain electrodes has a very high voltage equal to or higher than 155V. Hence, the drive efficiency is bad.

Considering the descriptions with reference to FIGS. 7 to 9, the ratio d/h of the shortest interval d between the scan and sustain electrodes to the height h of the barrier rib may lie substantially in a range between 0.35 and 1.1, or between 0.43 and 0.85, or between 0.55 and 0.65.

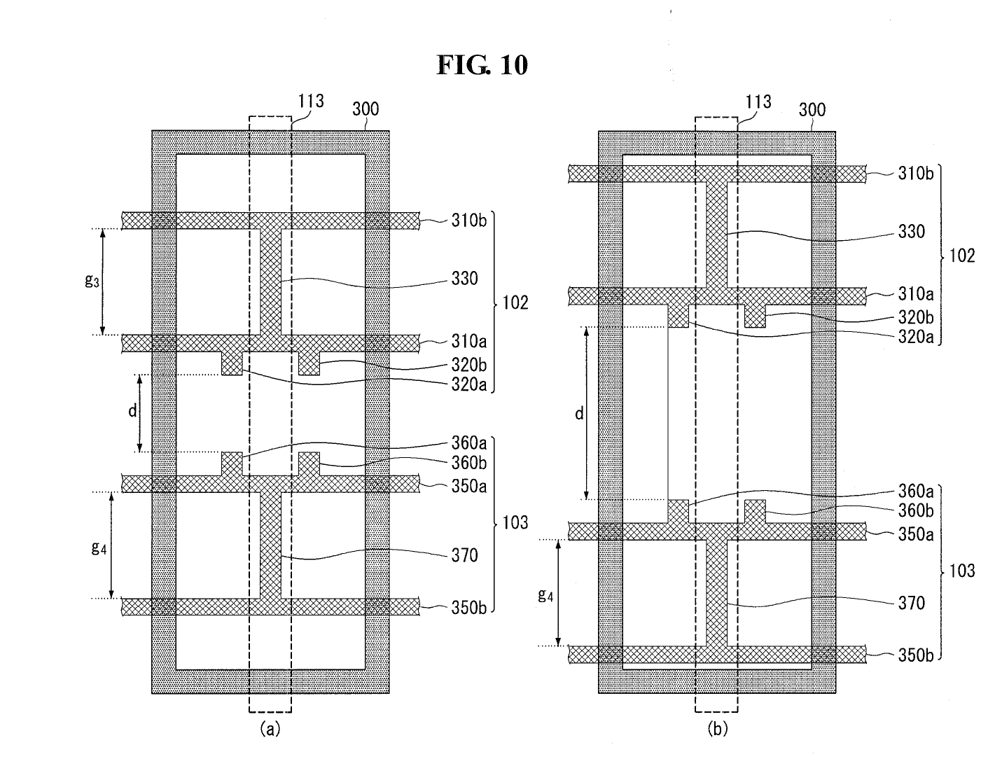

FIG. 10 is a diagram for explaining a shortest distance between scan and sustain electrodes.

As shown in (a) of FIG. 10, the shortest interval d between the scan and sustain electrodes 102 and 103 may be smaller than the interval g3 or g4 between the two line portions of at least one of the scan and sustain electrodes 102 and 103, so as to prevent an excessive rise of a firing voltage between the scan and sustain electrodes 102 and 103.

On the contrary, as shown in (b) of FIG. 10, if the shortest interval d is larger than the intervals g3 and g4, a firing voltage between the scan and sustain electrodes 102 and 103 may excessively rise because of the very long interval d.

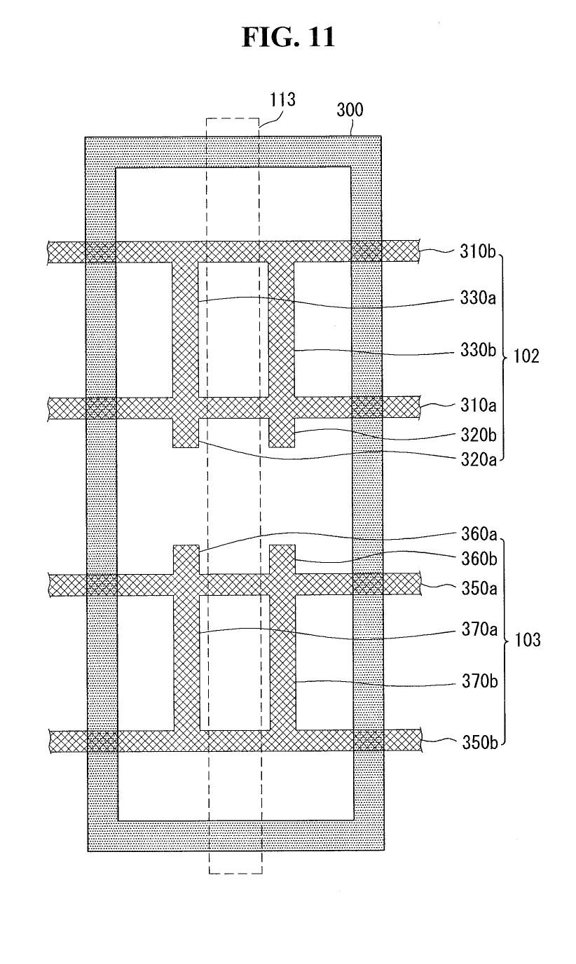

FIG. 11 is a diagram for explaining an example of another form of a connection portion.

As shown in FIG. 11, the scan electrode 102 may include 1-1 and 1-2 connection portions 330a and 330b for connecting the first and second line portions 310a and 310b, and the sustain electrode 103 may include 2-1 and 2-2 connection portions 370a and 370b for connecting the first and second line portions 350a and 350b.

Because the scan electrode 102 and the sustain electrode 103 each include the plurality of connection portions, a discharge generated between the scan electrode 102 and the sustain electrode 103 can be easily diffused into the rear of the discharge cell.

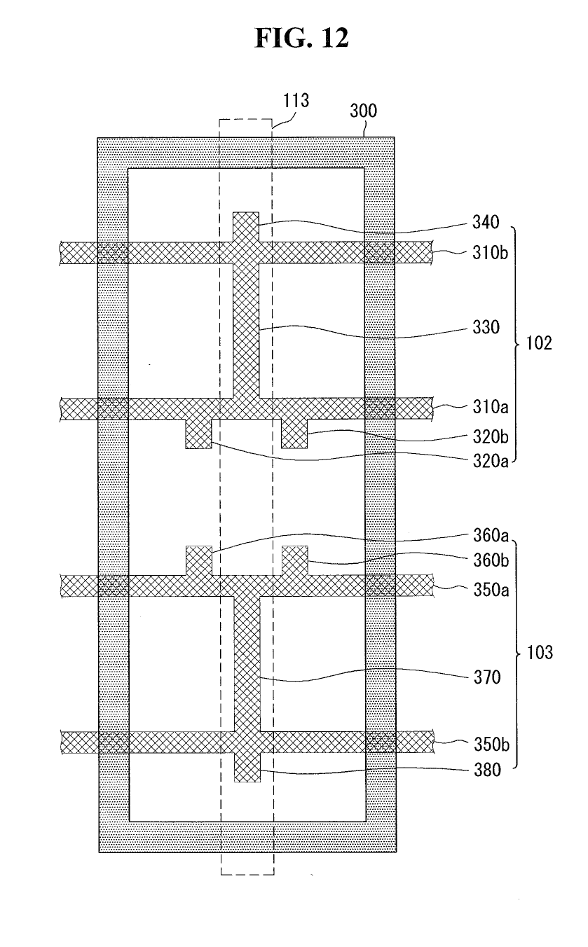

FIG. 12 is a diagram for explaining an example of the case where scan and sustain electrodes each include a tall portion.

As shown in FIG. 12, the scan electrode 102 may include a tail portion 340 that projects in a direction different from a projecting direction of the projecting portions 320a and 320b, and the sustain electrode 103 may include a tail portion 380 that projects in a direction different from a projecting direction of the projecting portions 360a and 360b.

The projecting direction of the tail portions 340 and 380 may be opposite to the projecting direction of the projecting portions 320a, 320b, 360a, and 360b. A length or a width of the tail portions 340 and 380 may be equal to or different from a length or a width of the projecting portions 320a, 320b, 360a, and 360b.

Because the scan electrode 102 and the sustain electrode 103 further include the tail portions 340 and 380, respectively, a discharge generated between the scan electrode 102 and the sustain electrode 103 can be easily diffused into the rear of the discharge cell.

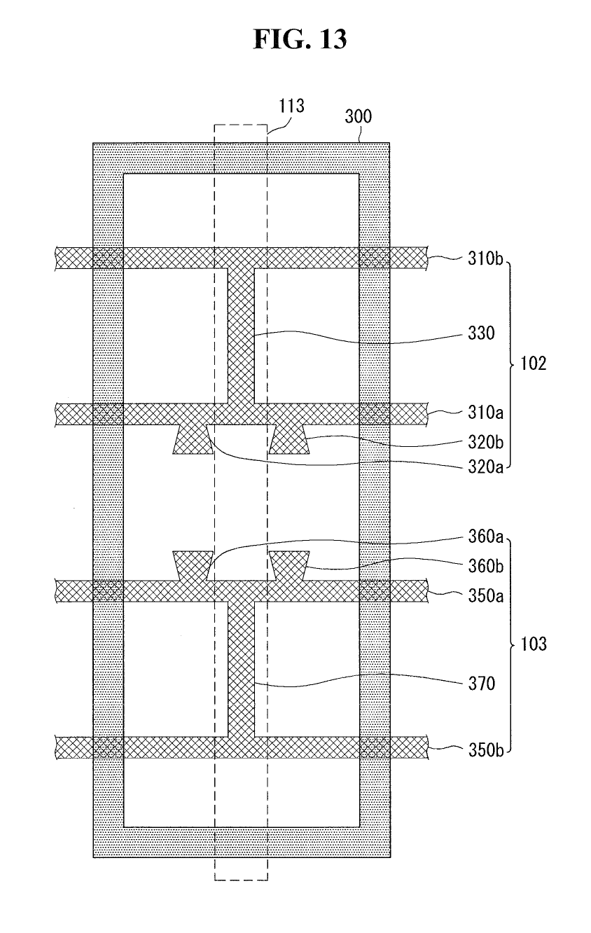

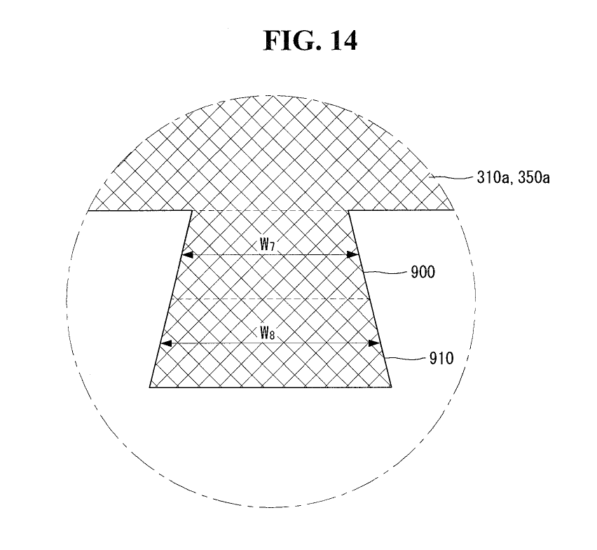

FIGS. 13 and 14 is a diagram for explaining an example of another form of a projecting portion.

As shown in FIGS. 13 and 14, each of the projecting portions 320a, 320b, 360a, and 360b may include a first portion 910 and a second portion 900 between the first portion 910 and the line portions 310a and 350a. A width W8 of the first portion 910 may be larger than a width W7 of the second portion 900. For instance, the projecting portions 320a, 320b, 360a, and 360b may have an increasing width as they go from the line portions 310a and 350a toward the center of the discharge cell.

On the contrary, if the projecting portions 320a, 320b, 360a, and 360b have a decreasing width as they go from the line portions 310a and 350a toward the center of the discharge cell, wall charges may be concentrated on the first portion 910 having a relatively small width during a discharge. Hence, the discharge may unstably occur. Because the wall charges are excessively concentrated on the first portion 910, the first portions 910 of the projecting portions 320a, 320b, 360a, and 360b may burn.

However, in case that the width W8 of the first portion 910 is larger than the width W7 of the second portion 900 as shown in FIGS. 13 and 14, wall charges can be uniformly distributed on the first portion 910 of the projecting portions 320a, 320b, 360a, and 360b during a discharge. Hence, the discharge can stably occur.

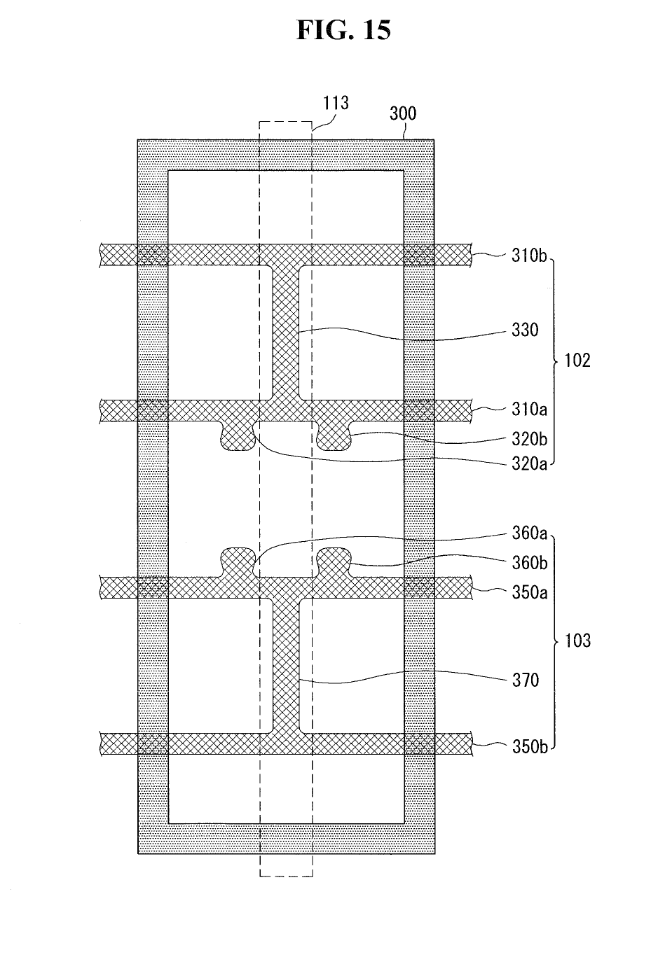

FIG. 15 is a diagram for explaining an example of a projecting portion with the curvature.

As shown in FIG. 15, at least one of the projecting portions 320a, 320b, 360a, and 360b of the scan and sustain electrodes 102 and 103 may include a portion with the curvature. Further, a portion where the projecting portions 320a, 320b, 360a, and 360b intersect the line portions 310a, 310b, 350a, and 350b may have the curvature. A portion where the line portions 310a, 310b, 350a, and 350b intersect the connection portions 330 and 370 may have the curvature.

As above, because the scan electrode 102 and the sustain electrode 103 include the portion with the curvature, the scan electrode 102 and the sustain electrode 103 can be manufactured using a simple process. Further, because wall charges can be prevented from being excessively concentrated on a specific location during a discharge, the discharge can stably occur.

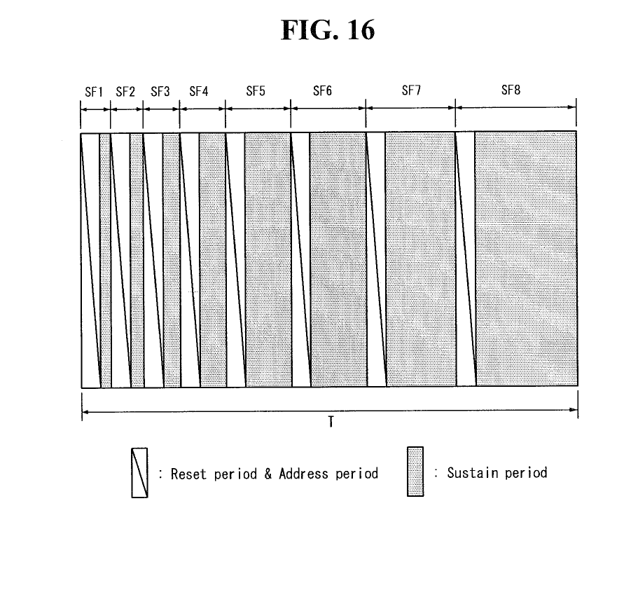

FIG. 16 shows a frame for achieving a gray scale of an image in the plasma display apparatus.

As shown in FIG. 16, a frame for achieving a gray scale of an image displayed by the plasma display apparatus may be divided into a plurality of subfields each having a different number of emission times.

Although it is not shown, at least one of the plurality of subfields may be subdivided into a reset period for initializing the discharge cells, an address period for selecting cells to be discharged, and a sustain period for representing gray level depending on the number of discharges.

For example, if an image with 256-level gray scale is to be displayed, a frame, as shown in FIG. 16, is divided into 8 subfields SF1 to SF8. Each of the 8 subfields SF1 to SF8 is subdivided into a reset period, an address period, and a sustain period.

The number of sustain signals supplied during the sustain period may determine a weight value of each subfield. For example, in such a method of setting a weight value of a first subfield at 2⁰ and a weight value of a second subfield at 2¹, a weight value of each subfield may be set so that a weight value of each subfield increases in a ratio of 2ⁿ (where, n=0, 1, 2, 3, 4, 5, 6, 7). Various images with various gray scales can be displayed by adjusting the number of sustain signals supplied during a sustain period of each subfield depending on a weight value of each subfield.

Although FIG. 16 has shown and described the case where one frame includes 8 subfields, the number of subfields constituting one frame may vary. For example, one frame may include 10 or 12 subfields.

Further, although FIG. 16 has illustrated and described the subfields arranged in increasing order of weight values, the subfields may be arranged in decreasing order of weight values, or the subfields may be arranged regardless of weight values.

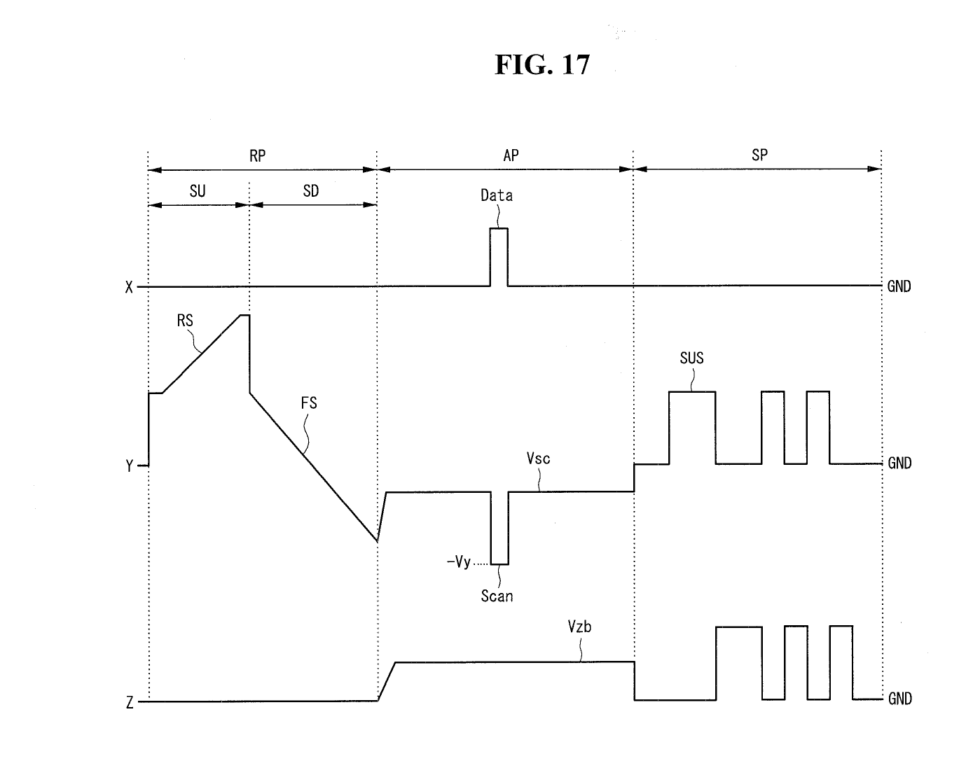

FIG. 17 is a diagram for explaining an example of an operation of the plasma display panel.

As shown in FIG. 17, a rising signal RS and a falling signal FS may be supplied to the scan electrode Y during a reset period RP for initialization of at least one subfield of a plurality of subfields of a frame. For instance, the rising signal RS may be supplied to the scan electrode Y during a setup period SU of the reset period RP, and the falling signal FS may be supplied to the scan electrode Y during a set-down period SD following the setup period SU.

When the rising signal RS is supplied to the scan electrode Y, a weak dark discharge (i.e., a setup discharge) occurs inside the discharge cell due to the rising signal RS. Hence, the remaining wall charges can be uniformly distributed inside the discharge cell.

When the falling signal FS is supplied to the scan electrode Y after the supply of the rising signal RS, a weak erase discharge (i.e., a set-down discharge) occurs inside the discharge cell. Hence, the remaining wall charges can be uniformly distributed inside the discharge cells to the extent that an address discharge occurs stably.

During an address period AP following the reset period RP, a scan bias signal Vsc having a voltage higher than a lowest voltage of the falling signal FS may be supplied to the scan electrode Y. A scan signal Scan falling from the scan bias signal Vsc may be supplied to the scan electrode Y during the address period AP.

A width of a scan signal supplied to the scan electrode during an address period of at least one subfield may be different from widths of scan signals supplied during address periods of the other subfields. For instance, a width of a scan signal in a subfield may be larger than a width of a scan signal in a next subfield in time order. A width of a scan signal may be gradually reduced in the order of 2.6 μs, 2.3 μs, 2.1 μs, 1.9 μs, etc., or may be reduced in the order of 2.6 μs, 2.3 μs, 2.3 μs, 2.1 μs, . . . , 1.9 μs, 1.9 μs, etc., in the successively arranged subfields.

When the scan signal Scan is supplied to the scan electrode Y, a data signal Data corresponding to the scan signal Scan may be supplied to the address electrode X.

As the voltage difference between the scan signal Scan and the data signal Data is added to a wall voltage by the wall charges produced during the reset period RP, an address discharge can occur inside the discharge cells to which the data signal Data is supplied.

During a sustain period SP following the address period AP, a sustain signal SUS may be supplied to at least one of the scan electrode Y or the sustain electrode Z. For instance, the sustain signals SUS may be alternately supplied to the scan electrode Y and the sustain electrode Z.

As the wall voltage inside the discharge cells selected by performing the address discharge is added to a sustain voltage of the sustain signal SUS, every time the sustain signal SUS is supplied, a sustain discharge (i.e., a display discharge) can occur between the scan electrode Y and the sustain electrode Z. Hence, an image can be displayed on the screen of the plasma display panel.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display panel comprising:
a front substrate on which a scan electrode and a sustain electrode are positioned parallel to each other, the scan electrode and the sustain electrode each having a single-layered structure;
a rear substrate on which an address electrode is positioned to intersect the scan electrode and the sustain electrode; and
a barrier rib that is positioned between the front substrate and the rear substrate to partition a discharge cell,
wherein the scan electrode and the sustain electrode each include:
at least one line portion intersecting the address electrode;
at least one projecting portion that projects from the at least one line portion toward the center of the discharge cell; and
a connection portion that connects the at least two line portions to each other,
wherein a ratio of a shortest interval between the scan electrode and the sustain electrode to a height of the barrier rib lies substantially in a range between 0.35 and 1.1.

2. The plasma display panel of claim 1, wherein the ratio of the shortest interval between the scan electrode and the sustain electrode to the height of the barrier rib lies substantially in a range between 0.43 and 0.86.

3. The plasma display panel of claim 1, wherein the ratio of the shortest interval between the scan electrode and the sustain electrode to the height of the barrier rib lies substantially in a range between 0.55 and 0.65.

4. The plasma display panel of claim 1, wherein the shortest interval between the scan electrode and the sustain electrode is substantially equal to an interval between the projecting portion of the scan electrode and the projecting portion of the sustain electrode.

5. The plasma display panel of claim 1, wherein a width of the connection portion is equal to or smaller than a width of the line portion.

6. The plasma display panel of claim 1, wherein the projecting portion includes a portion with the curvature.

7. The plasma display panel of claim 1, wherein the shortest interval between the scan electrode and the sustain electrode is smaller than an interval between the two line portions of at least one of the scan electrode and the sustain electrode.

8. A plasma display panel comprising:
a front substrate on which a scan electrode and a sustain electrode are positioned parallel to each other, the scan electrode and the sustain electrode each having a single-layered structure;
a rear substrate on which an address electrode is positioned to intersect the scan electrode and the sustain electrode; and
a barrier rib that is positioned between the front substrate and the rear substrate to partition a discharge cell,
wherein the scan electrode and the sustain electrode each include:
at least one line portion intersecting the address electrode;
at least one projecting portion that projects from the at least one line portion toward the center of the discharge cell, the projecting portion including a first portion and a second portion between the first portion and the line portion, a width of the first portion being larger than a width of the second portion; and
a connection portion that connects the at least two line portions to each other,
wherein a ratio of a shortest interval between the scan electrode and the sustain electrode to a height of the barrier rib lies substantially in a range between 0.35 and 1.1.

9. The plasma display panel of claim 8, wherein the ratio of the shortest interval between the scan electrode and the sustain electrode to the height of the barrier rib lies substantially in a range between 0.43 and 0.86.

10. The plasma display panel of claim 8, wherein the ratio of the shortest interval between the scan electrode and the sustain electrode to the height of the barrier rib lies substantially in a range between 0.55 and 0.65.

11. The plasma display panel of claim 8, wherein the shortest interval between the scan electrode and the sustain electrode is substantially equal to an interval between the projecting portion of the scan electrode and the projecting portion of the sustain electrode.

12. The plasma display panel of claim 8, wherein a width of the connection portion is equal to or smaller than a width of the line portion.

13. The plasma display panel of claim 8, wherein the projecting portion includes a portion with the curvature.

14. The plasma display panel of claim 8, wherein the shortest interval between the scan electrode and the sustain electrode is smaller than an interval between the two line portions of at least one of the scan electrode and the sustain electrode.

15. A plasma display panel comprising:
a front substrate on which a scan electrode and a sustain electrode are positioned parallel to each other, the scan electrode and the sustain electrode each having a single-layered structure;
a rear substrate on which an address electrode is positioned to intersect the scan electrode and the sustain electrode; and
a barrier rib that is positioned between the front substrate and the rear substrate to partition a discharge cell,
wherein the scan electrode and the sustain electrode each include:
at least one line portion intersecting the address electrode;
at least one projecting portion that projects from the at least one line portion toward the center of the discharge cell; and
a connection portion that connects the at least two line portions to each other,
wherein a ratio of a shortest interval between the scan electrode and the sustain electrode to a height of the barrier rib lies substantially in a range between 0.35 and 1.1,
wherein at least one of an interval between the two projecting portions of the scan electrode and an interval between the two projecting portions of the sustain electrode is larger than a width of the address electrode.

16. The plasma display panel of claim 15, wherein the ratio of the shortest interval between the scan electrode and the sustain electrode to the height of the barrier rib lies substantially in a range between 0.43 and 0.86.

17. The plasma display panel of claim 15, wherein the ratio of the shortest interval between the scan electrode and the sustain electrode to the height of the barrier rib lies substantially in a range between 0.55 and 0.65.

18. The plasma display panel of claim 15, wherein the shortest interval between the scan electrode and the sustain electrode is substantially equal to an interval between the projecting portion of the scan electrode and the projecting portion of the sustain electrode.

19. The plasma display panel of claim 15, wherein a width of the connection portion is equal to or smaller than a width of the line portion.

20. The plasma display panel of claim 15, wherein the projecting portion includes a portion with the curvature.

21. The plasma display panel of claim 15, wherein the shortest interval between the scan electrode and the sustain electrode is smaller than an interval between the two line portions of at least one of the scan electrode and the sustain electrode.
